(19) United States
(12) Patent Application Publication
(10) Pub. No.: US 2018/0247534 A1
(43) Pub. Date: Aug. 30, 2018

(54) INTEGRATED SYSTEM FOR MONITORING PARKING LOT CONDITIONS

(71) Applicant: Christopher Williams, Bloomington, IN (US)

(72) Inventor: Christopher Williams, Bloomington, IN (US)

(21) Appl. No.: 15/904,847

(22) Filed: Feb. 26, 2018

Related U.S. Application Data
(60) Provisional application No. 62/463,208, filed on Feb. 24, 2017.

(51) Int. Cl. G08G 1/14; G08G 1/056; G08G 1/01

(52) U.S. Cl. CPC G08G 1/141; G08G 1/0137; G08G 1/056

(57) ABSTRACT

A system that can automatically monitor the capacity of a parking lot by detecting the entering and exiting of vehicles. Two sensors detect the entering and exiting of vehicles by determining which sensor detects the vehicle first

### CROSS REFERENCE TO RELATED APPLICATIONS

The present application claims the benefit of U.S. Provisional Application 62/463,208, filed Feb. 24, 2017, titled “Integrated System for Monitoring Parking Lot Conditions” to Christopher Williams, the entire disclosure of which is hereby incorporated by reference.

### FIELD OF THE DISCLOSURE

The present embodiments relate to a system for monitoring parking lot occupancy and parking lot environmental conditions and proving users access to parking lot data.

### BACKGROUND OF THE INVENTION

Parking lots and parking garages have become increasingly important as the populations of large cities increase. Drivers like to know when they are driving into the city if they will have a parking lot that they will be able to park in. This has led to a large growth in phone apps for reserving parking spaces. The trouble with these apps is they do not always have a good system in place to determine the number of cars that are already in that parking lot.

When these systems are not kept fully up to date in real time someone can get to a parking lot only to find that it is already full, and they must find somewhere else to park. This can be due to the system not updating frequently enough, or the systems in place to monitor the number of free spaces does not accurately gauge the number of vehicles in the parking lot. These parking lots would benefit from a system that can more accurately determine the number of open spaces in a parking lot and keep this number updated in real time.

### SUMMARY OF THE DISCLOSURE

The present disclosure relates to a parking lot capacity system. The system includes at least first and second sensors. The first and second sensors are each positionable to detect vehicles entering and exiting a parking lot. The system further includes at least one processor configured to receive data from the at least first and second sensors to determine the capacity of the parking lot.

According to the present disclosure, a method for determining the capacity of a parking lot is provided. The method includes the steps of providing a parking lot capacity system having at least first and second sensors. The first and second sensors are positionable to detect vehicles entering and exiting a parking lot. The parking lot capacity sensor further has at least one processor configured to receive data from the at least first and second sensors to determine the capacity of the parking lot. The method further includes a step of determining whether a vehicle is entering or exiting the parking lot based on which of the first and second sensors detects the vehicle first.

Additional features of the present disclosure will become apparent to those having skill in the art upon consideration of the following detailed description of the illustrative embodiment exemplifying the best mode of carrying out the disclosure as presently perceived.

### BRIEF DESCRIPTION OF THE DRAWINGS

The detailed description of the drawings particularly refers to the accompanying figures in which:

FIG. 1 schematically illustrates an aerial view of the parking lot occupancy system;

FIG. 2 schematically illustrates the active infrared sensor units that monitor parking occupancy;

FIG. 3 schematically illustrates the payment station and records environmental and occupancy data;

FIG. 4 schematically illustrates a device used to monitor an individual parking space using magnetic fields; and

FIG. 5 is a view of a mobile device, such as a smart phone, showing a plurality of parking lots and indicating how many parking spots are available in each respective parking lot.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. Unless otherwise indicated or apparent, the components shown in the figures are proportional to each other. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION OF THE DRAWINGS

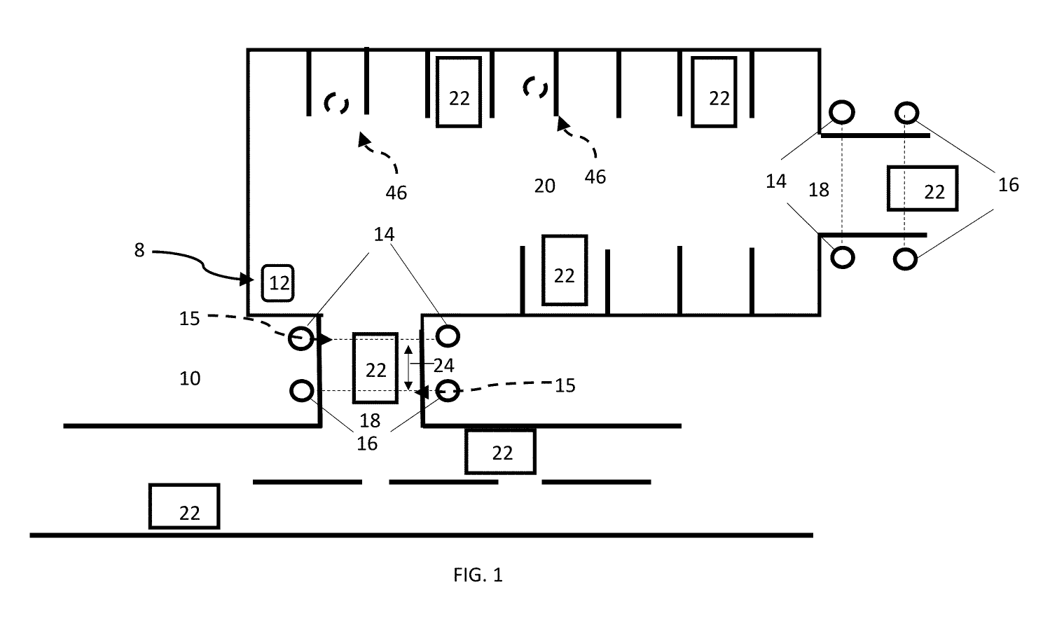

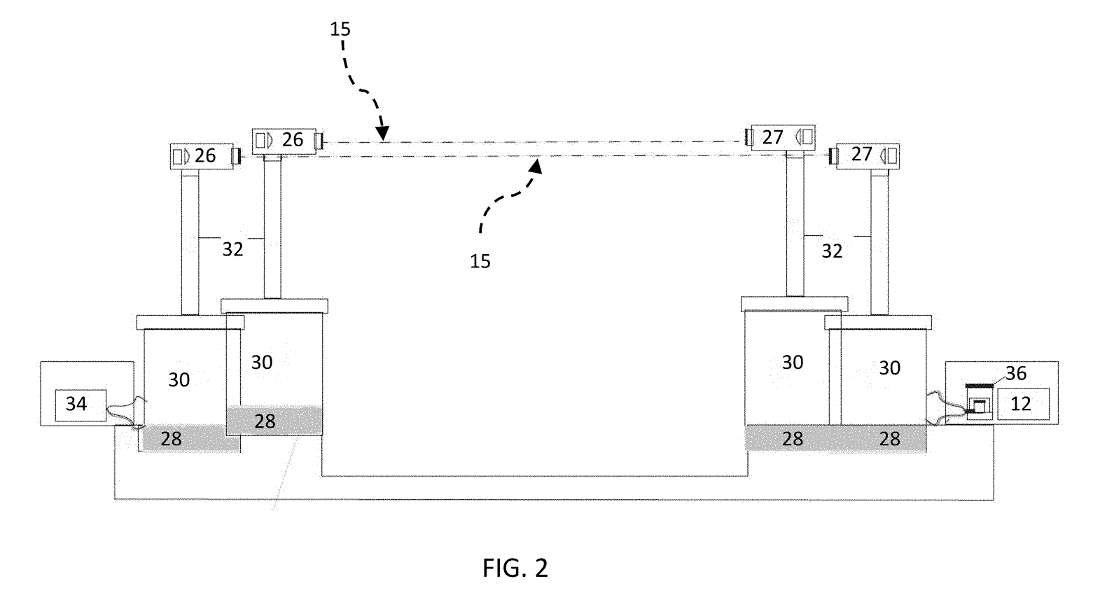

As depicted in FIG. 1, a parking lot occupancy system 10 is provided. Occupancy system 10 includes a local computer 12 (housed in a payment station 8, FIG. 2) and at least two active infrared sensor pairs 14, 16 placed at an entrance 18 of a parking lot 20 to record the entry and exit of automobiles, such as cars 22. Sensor pairs 14, 16 transmit and receive beams 15 and is in communication with local computer 12. Ideally, one sensor pair 14 is spaced slightly less than car's length 24 from the other sensor pair 14 so local computer 12 only counts the entry and exit of cars 22 (which happens when both beams 15 are broken simultaneously).

As depicted in FIG. 2, each sensor pair 14, 16 includes an infrared transmitter 26 and an infrared receiver 27 are located above a bucket 30, at least partially filled with concrete 28, on top of a riser 32 that makes each beam 15 perpendicular to car 22.

As suggested above, to distinguish between cars 22 and other objects, beams 15 are spaced slightly less than car's length 24 apart to detect when both beams 15 are broken simultaneously by car 22. When computer 12 detects that both beams are broken, it assumes that a car 22 has passed through entrance/exit 18 of the parking lot.

Depending on the sequence of the breaking of beams 15, system 10 knows whether car 22 is entering or exiting the parking lot. If beam 15 closest to a street adjacent the parking lot is broken first, system 10 registers an entrance. If beam 15 closest to the parking lot is broken first, system 15 registers an exit. By knowing the capacity of the parking lot and subtracting from the capacity for each car 22 that enters and adding to the capacity for each car 22 that leaves, system 10 knows how many parking spaces are vacant. Additionally, by monitoring the number of parking spots, someone monitoring system 10 can determine when cars are left over night, peak (and low) usage times for the parking lot, etc. If cars 22 are left after a designated time, those cars 22 can be towed. The pricing structure of the parking lot can be adjusted based on occupancy: charging more when the lot is close to full and less and the lot is not as full.

A battery 34, powers transmitters 26, receivers 27, and computer 12. Computer 12 records counting information. Computer 12 keeps track of the total number of cars 22 in the parking lot (based on the difference between automobile entries and exits), and this number is communicated to a database located on a central, external server (not shown).

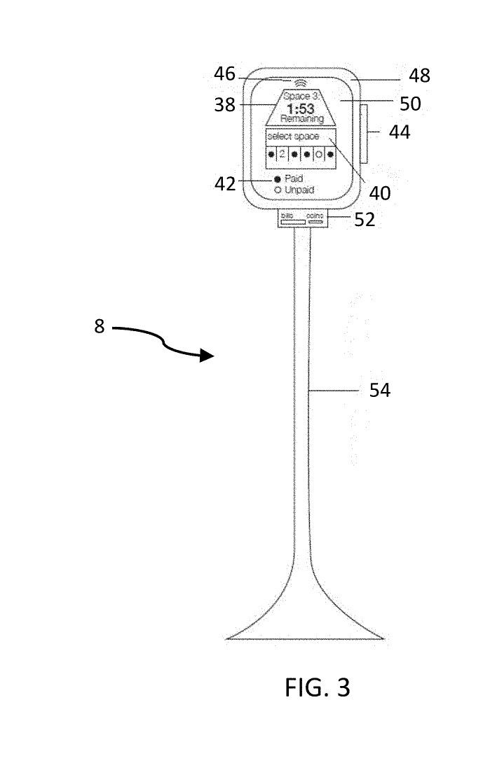

As depicted in FIG. 3, payment station 8 collects data on environmental and parking lot occupancy and transmits the data to the central server. Additionally, payment station 8 may receive payments from parking lot users. Station 8 includes an LCD display 38 that gives individual user information, such as the location of a parking space and the time remaining. It also consists of a touch screen 40 that allows users to communicate with station 8. Beneath screen 40, an indicator 42 tells users whether or not a particular parking spot has been paid for.

To the side of screen 40, a card slot 44 accepts credit cards and thereby allows users to pay for parking directly from a credit or debit account. A near field communication (NFC) protocol 46 enables users to interact with payment station 8 using a smartphone, and thus make payments from a mobile device 47, see FIG. 5.

Screen 40 of payment station 8 is included within an outer enclosure 48 and an inner enclosure 50. Payment station 8 includes a physical currency counter/safe 52 which allows users to pay for a parking space using physical currency, such as dollars and coins, and store and protect collected currency. Payment station 8 includes a stand 54 situating most of station 8 at eye-level for most users.

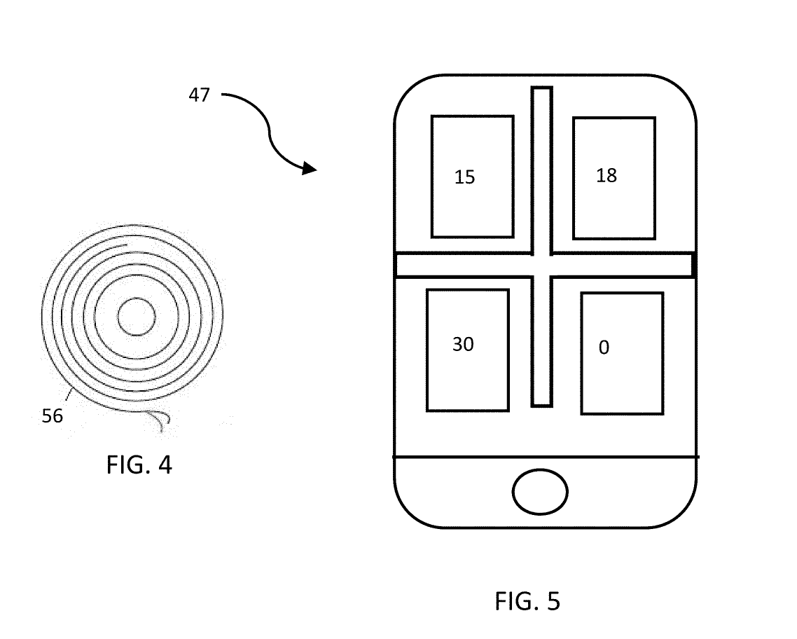

As depicted in FIG. 4, a magnetometer 46, which consists of iron, a copper wire, and an adaptor, can detect changes in a magnetic field at individual parking spaces. In this way the occupancy of an individual parking space, usually located on a street, can be monitored by computer 12. A few magnetometers 46 are shown in FIG. 1. According to the preferred embodiment, a few select parking spots (ex. handicap parking spots) are provided with magnetometers 46. According to another embodiment, every parking spot includes a magnetometer 46.

As shown in FIG. 5, mobile device 47 is provided with an application, hereinafter “app,” that is in communication with the central server. Based on the GPS or other location of mobile device 47, the app displays parking lots in the vicinity of mobile device 47 that are monitored by parking lot occupation system 10 described herein. The central server provides mobile device 47 with current number of parking spots open in the respective lots. For example, as shown in FIG. 5, of four parking lots located near an intersection, one has 15 spots, one has 18 spots, one has 30 spots, and another is full. Other indicators of capacity may also be provided. For example, according to one embodiment, full lot are colored red, almost full lots are colored yellow, and less fully lots are colored green.

Thus, the user of mobile device 47 can determine which lots have open parking spaces. Additionally, using data from magnetometers 46, the central server can indicate home many handicap spots are currently available.

What is claimed is:

1. A parking lot capacity system including,
at least first and second sensors, the first and second sensors each being positionable to detect vehicles entering and exiting a parking lot, and
at least one processor configured to receive data from the at least first and second sensors to determine the capacity of the parking lot.

2. The parking lot capacity system of claim 1, wherein:
the at least one processor is configured to determine whether a vehicle is entering or exiting a parking lot based on which of the first and second sensors detects the vehicle first.

3. The parking lot capacity system of claim 2, wherein:
the at least one processor detects when the first and second sensors simultaneously detect a vehicle.

4. The parking lot capacity system of claim 3, wherein:
the first and second sensors are spaced apart a distance in the direction of the flow of the vehicles that is greater than 72 inches and less than 100 inches.

5. The parking lot capacity system of claim 1, wherein:
the at least one processor detects when the first and second sensors simultaneously detect a vehicle.

6. The parking lot capacity system of claim 1, wherein:
the first and second sensors are spaced apart a distance in the direction of the flow of the vehicles that is greater than 72 inches and less than 100 inches.

7. The parking lot capacity system of claim 1, further including:
at least a first and second transmitters positionable to send a signal toward the first and second sensors.

8. A method for determining the capacity of a parking lot, the method including the steps of:
providing a parking lot capacity system having at least first and second sensors, the first and second sensors being positionable to detect vehicles entering and exiting a parking lot, and the parking lot capacity sensor further having at least one processor configured to receive data from the at least first and second sensors to determine the capacity of the parking lot, and;
determining whether a vehicle is entering or exiting the parking lot based on which of the first and second sensors detects the vehicle first.

9. The method of claim 8, wherein:
the first sensor is positioned closer to an egress point of the parking lot than the second sensor.

10. The method of claim 9, wherein:
the determining step determines that a vehicle enters the parking lot if the first sensor detects the vehicle before the second sensor detects the vehicle and, determines that a vehicle exits the parking lot if the second sensor detects the vehicle before the first sensor detects the vehicle.

11. The method of claim 9, further including the steps of:
decreasing the capacity of the parking lot when the first sensor detects a vehicle before the second sensor detects the vehicle and;
increasing the capacity of the parking lot when the second sensor detects a vehicle before the first sensor detects the vehicle.

12. The method of claim 11, wherein:
the increasing step and the decreasing steps are in response to the first and second sensors simultaneously detecting a vehicle.

13. The method of claim 12, wherein:
the first and second sensors are spaced apart a distance in the direction of the flow of the vehicles that is greater than 72 inches and less than 100 inches.

14. The method of claim 11, further including a step of:
sending the capacity to a user seeking a parking spot after the determining step.

15. The method of claim 14, wherein:
the sending step results in a change of capacity detectable by the user.

16. The method if claim 15, wherein:
the change of the capacity is indicated by a change in color of a parking lot shown on a display accessible to the user.

17. The method of claim 8, further including a step of:
receiving a request from a user reserving a parking space in the parking lot, wherein the determining step decreases the capacity of the parking lot after the receiving step.

18. The method of claim 8, further including a step of:
determining the environmental conditions at the parking lot, and;
sending data based in the determined environmental conditions to a user seeking a parking spot.
